(19) United States
(12) Patent Application Publication
(10) Pub. No.: US 2003/0039223 A1
(43) Pub. Date: Feb. 27, 2003

(54) Synchronized bidirectional packet transmission method

(75) Inventor: Pierre Dupuy, Paris (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/106,252

(22) Filed: Mar. 27, 2002

(30) Foreign Application Priority Data
Mar. 29, 2001 (FR) 01 04 253

(51) Int. Cl. H04Q 7/00

(52) U.S. Cl. 370/328; 370/336

(57) ABSTRACT

A synchronized bidirectional packet transmission method between a base station of a radiocommunication network and a transcoder unit including at least two transcoders, forming part of a fixed telephone network or the like and connected to the base transceiver station, in particular to transmit voice or sound information or data, which method uses a downlink priority order for the time slots of a frame that is reversed relative to that applied to or existing on the uplink.

### CROSS-REFERENCE TO RELATED APPLICATIONS

This application is based on French Patent Application No. 01 04 253 filed Mar. 29, 2001, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to transmission between telecommunication networks, in particular transmission of speech and sounds between a fixed telecommunication network and a Global System for Mobile communications (GSM) or like radiocommunication network, and consists primarily in a bidirectional packet transmission method used in a network featuring minimized transmission time-delays, in particular time-delays due to packetizing data and information for transmission to a radiocommunication network.

2. Description of the Prior Art

Radiocommunication networks all essentially include two types of components, namely, on the one hand, base transceiver stations (BTS) distributed over the territory covered by the network concerned and constituting a subdivision into cells and, on the other hand, transcoder units (TC) connected to each other or to other systems or devices connected to the network via said base transceiver stations.

Mobile radiocommunication networks are often connected to the fixed telephone network, which necessitates transcoding speech and sounds from a form compatible with one type of network into a form compatible with the other type and vice versa.

In this document, the term “uplink” refers to any connection or transmission from a terminal of the fixed telephone network to a radiocommunication network, i.e. to the base transceiver stations, and the term “downlink” refers to any connection or transmission in the opposite direction.

The present invention is aimed more particularly at the operations of packetizing and depacketizing data or information transmitted during a directional call between a base transceiver station and one or more terminals of a fixed telephone network.

These operations are generally based on packetizing data and information to be transmitted by applying the Internet Protocol (IP).

In the particular case, taken as an alternative example, of a base station subsystem (BSS) of a GSM circuit, the voice time-delay is defined in GSM specification 03.05. The passage from circuit to IP protocol introduces significant changes into the balance of time-delays.

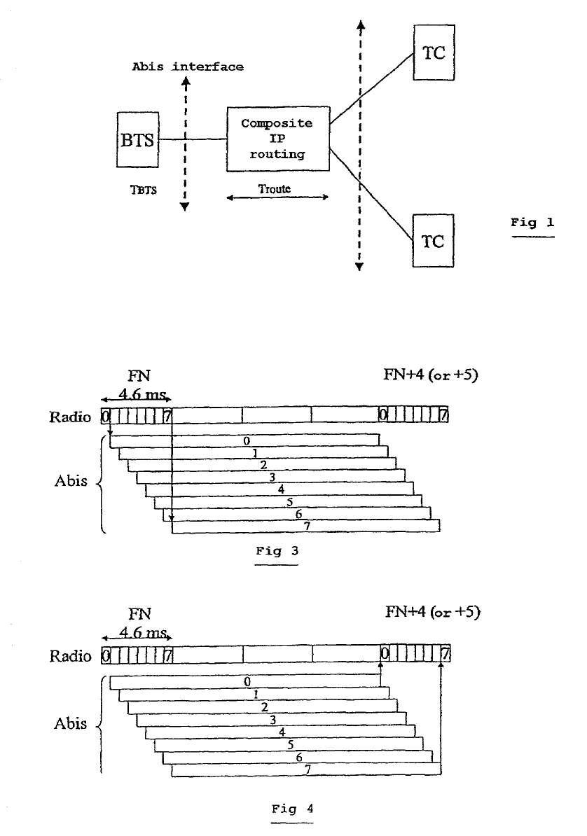

FIG. 1 of the accompanying drawing shows diagrammatically and symbolically a typical architecture for transmission of speech and sound between a fixed telephone network and a radiocommunication network.

The “composite IP routing” block has the following functions:

uplink: it opens the composite IP frame and retransmits each packet to the appropriate transcoder TC;

downlink: it collects the voice IP packets coming from the transcoder TC in composite IP frames and sends them to the appropriate BTS.

In addition to the packetizing time-delay referred to in this document, the following time-delays can be identified:

TBTS: this is the time-delay between receiving the last bit of the time slot at the antenna and transmission of the first decoded bit at the Abis interface which provides the terrestrial communication between the BTS and the base station controller (BSC). There is a corresponding downlink time-delay.

Troute: this is the time-delay between the end of transmission of an IP composite frame to the BTS and the reception of that frame in the composite IP routing context. There may be a different downlink time-delay.

TTC represents the time-delay between receiving an IP composite frame in the composite IP routing context and receiving a TCH voice frame contained in the field TC in that IP frame. There may be a different downlink time-delay.

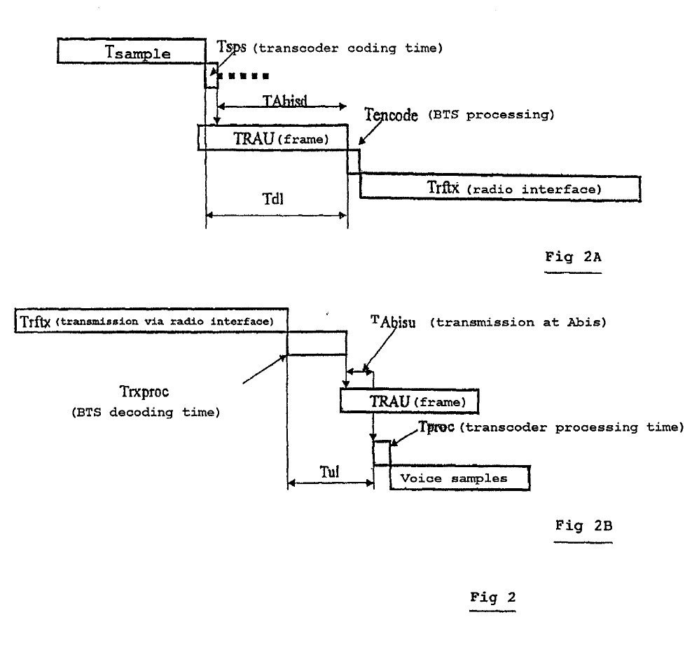

FIGS. 2A and 2B indicate downlink transmission scheduling (using abbreviations taken from GSM specification 03.05), respectively at the level of the Abis interface and the Radio interface.

In both cases, note that the TRAU frame is launched slightly ahead of time to minimize the transmission time: all the bits of the header which are independent of the result of coding or decoding are sent in advance.

The time-delay which depends on the transmission principle is the time-delay Tdl for the downlink and the time-delay Tul for the uplink. The time-delay Tdl includes the time taken by the coder to deliver the first coded voice bits and the time to transmit all of them at the Abis interface. The time-delay Tul includes the time for transmitting sufficient coded voice to the transcoder for it to be able to decode it and start to generate voice.

The full rate time distribution can be as defined in the specification 03.05 previously cited, for example.

With regard to the downlink, the portion of the time-delay that is of interest in the context of the present application is Tsps+Tabisd=19 ms (16 kbit/s Abis interface).

The time-delay Tsps represents the time needed for the transcoder to generate the first voice information bit at the Abis interface.

Note that in a practical implementation, the definition of the time-delay Tsps can differ from that given above, in that specification 03.05 presupposes that the voice coder is capable of supplying the bits two by two to the transmission control module. In reality, the software constraints are such that the coder can deliver longer bursts of bits by increasing the value of the time-delay Tsps in this way.

Also, this technique as used for circuit mode cannot be used for IP transmission: the voice coding must be completely finished before supplying it to the module controlling transmission. This means that the time-delay Tsps (1.6 ms) must be replaced by the time-delay Ttransc (8 ms).

Because of spectacular improvements in digital signal processors (DSP), the time-delays Tsps and Ttransc currently have values of around: Tsps=0.2 ms and Ttransc=0.8 ms.

Also, there is a margin of 1 ms in the base station controller, which can be used for other purposes.

With regard to the uplink, and in relation to the specification previously cited, the portion of the time-delay that is of interest is Tabisu=4 ms.

In total, the time-delay that depends on the transmission principle is that from the input of the coder to the input of the decoder, i.e. Tabisd+Tabisu+Transc.

The other portions of the time-delay are independent of the transmission principle.

There is also a margin of 4 ms (BTS and BSC).

For the half rate, specification 03.05 does not specify any value. The following hypotheses are valid:

Ttransc=7 ms

Tsps=1.4 ms (20% of Ttransc)

TAbisd=16.9 ms

TAbisu=9.6 ms

Other sources of transmission time-delays are tied to radio interface constraints.

Voice is transmitted at the radio interface with the following scheduling of the logical channels on the physical channels (extracted from GSM technical specification 05.02, see sections 6-3, 6-4 and 6-5).

| | | | Authorized | Length of | Scheduling of |
|---|---|---|---|---|---|
| | | | time | repeat in | interleaved |
| Channel | Subchannel | | slot | TDMA | blocks in |
| designation | No. | Direction | allocations | frames | TDMA frames |
| TCH/FS | | D&U² | 0 . . . 7 | 13 | B0(0 . . . 7). |
| | | | | | B1(4 . . . 11, |
| | | | | | B2(8 . . . 11,0 . . . 3) |
| TCH/FS | 0 | D&U² | 0 . . . 7 | 13 | B0(0,2,4,6), |
| | | | | | B1(4,6,8,10), |
| | | | | | B2(8,10,0,2), |
| | | | | | B0(1,3,5,7), |
| | | | | | B1(5,7,9,11), |
| | | | | | B2(9,11,1,3) |

FIG. 3 of the appended drawings indicates how uplink transmission at the Abis interface is scheduled as a function of reception of the last salvo of voice blocks (FN: frame number; FN+4: frame number+4 —4th following frame).

FIG. 4 of the accompanying drawings indicates how downlink voice blocks are scheduled at the Abis interface as a function of transmission of the corresponding first burst at the radio interface.

Note that in these two figures it is assumed that there is no processing time-delay in the BTS.

FIGS. 3 and 4 show that scheduling of voice blocks at the radio interface is highly sporadic: all of the information is used by the BTS or is made available during one quarter of the time provided. This sporadic scheduling is masked in the circuit mode at the Abis interface because all the traffic channels use independent physical channels.

There follows an analysis of the induced uplink and downlink time-delays related to calls in a GSM network using the Internet protocol. It is assumed that the BTS can generate the data stream without any limitation due to the internal architecture, and the following description relates to a BTS with 3×4 transceivers (TRX).

A composite IP frame is constructed to transport a plurality of traffic channels (TCH).

For example, assume that it contains 12 traffic channels.

Assuming that a full rate voice block contains 37 bytes and that the Internet Protocol service traffic consists of 6 bytes, this represents an IP frame of 486 bytes, transmitted in 1.96 ms. A half rate voice block contains 18 bytes. In both cases, it is assumed that there exists a service traffic of 4 bytes for addressing the subchannel and controlling the transcoder.

| | Voice | Control + | Channel | IP frame | Transmission |
|---|---|---|---|---|---|
| | byte | routing | total | (bytes) | time-delay |
| Full rate | 32.5 | 4.5 | 37 | 450 | 1.84 ms |
| Half rate | 14 | 4 | 18 | 222 | 0.91 ms |

The transmission time includes a 1.6% service traffic overload for HDLC protocol stuffing bits.

### Uplink Time-Delay

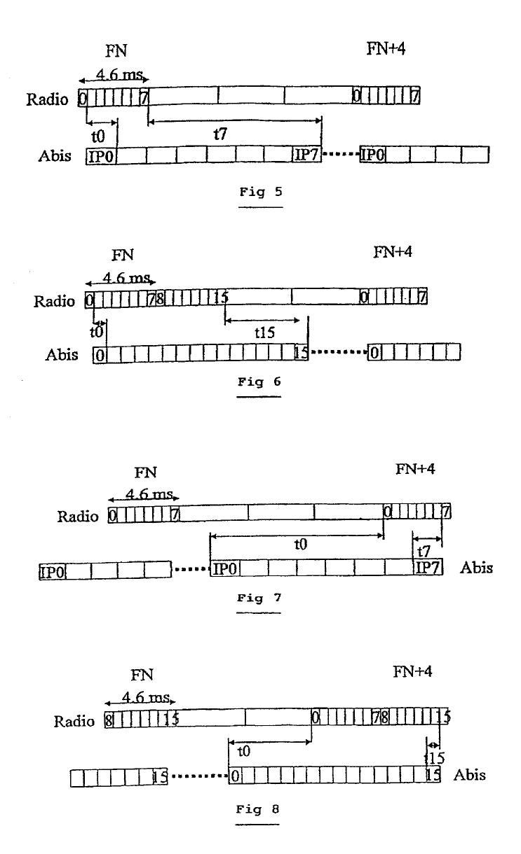

The simplest principle is to send the IP frames in the order in which they are decoded, as indicated for the full rate in the accompanying FIG. 5.

With the given input figures, the transmission time varies from 1.84 ms (t0) to 10.71 ms (t7).

On average, the transmission time is 6.3 ms, which is more than in the circuit mode (4 ms).

It can be seen that there is always a reserve time between the end of IP7 and the next block IPO: 3.6 or 8.2 ms (depending on the sequence 4/4/5 defined in Technical Specification 05.02).

FIG. 6 of the accompanying drawings shows the principle of FIG. 5 as applied to the half rate situation.

In this case, the time-delay varies from 0.91 to 5.80 ms. The average (3.4 ms) is less than that of the circuit mode.

### Downlink Time-Delay

Various problems rule out a scheduled arrangement on the downlink:

fine time alignment is not possible at call set-up time, because the round trip time to the transcoder is not known; the first IP frames arrive randomly, introducing unexpected time-delays on the connections set up;

because the portion of the equipment responsible for generating the composite IP frame is not normally aware of the organization of the radio time slots, it collects the incoming voice packets from the downlink as and when they arrive, mixing together voice blocks that are not necessarily scheduled for the same transmission time at the radio interface, introducing a high level of jitter;

if the BTS is not alerted to the transmission time-delay due to a bottleneck at the Abis interface, it attempts to optimize the time-delay to 0 for all the time slots.

Because of these problems, all the packets arrive in an anarchic manner, resulting in the generation of a high level of jitter, equivalent to the transmission time of all the IP frames (approximately 14.6 ms for the full rate or the half rate).

Also, the transcoder must execute the complete coding before transmitting the voice information (Ttransc).

This represents 0.8 ms for the full rate and 7 ms for the half rate and makes the total Tdl equal to the time needed to transmit all of the downlink IP composite frame (14.7 ms for the full rate, 14.6 for the half rate) plus the transcoding time (0.8 ms for the full rate and 7 ms for the half rate).

The total values obtained are set out in the table below:

| | Full rate | | Half rate | |
|---|---|---|---|---|
| | min | max | min | max |
| Tul | 1.8 | 10.7 | 9 | 5.8 |
| Tdl | 14.7 | 14.7 | 14.6 | 14.6 |
| Ttransc | 0.8 | 0.8 | 7 | 7 |
| Total | 17.3 | 26.2 | 22.5 | 27.4 |

Compared to the foregoing, an object of the present invention is to minimize generally the transmission time-delays in the context of packet transmission and in particular in the context of an application of the type previously cited.

### SUMMARY OF THE INVENTION

To this end, the present invention provides a synchronized bidirectional packet transmission method between a base station of a radiocommunication network and a transcoder unit including at least two transcoders, forming part of a fixed telephone network or the like and connected to the base transceiver station, in particular to transmit voice or sound information or data, which method uses a downlink priority order for the time slots of a frame that is reversed relative to that applied to or existing on the uplink.

The disposition previously cited consequently avoids, by relative compensation, an excessive time-delay for the time slot that is normally subject to the maximum penalty in consecutive uplink and downlink transmissions.

This result is obtained by optimized scheduling for the last uplink time slot, to compensate the longest uplink time-delay.

In the case of an implementation as described in the introductory portion of this description, transmission is scheduled for the full rate as shown in FIG. 7 of the accompanying drawings.

As a result, compared to the prior art, the transmission times are exactly reversed: from 10.71 ms for t0 to 1.84 ms for t7. The benefit is that there is no longer any best case/worst case: all the TCH have the same transmission time of 10.71+1.84=12.65 ms for the uplink and the downlink.

Taking into account the transcoding time-delay (0.8 ms), this results in a time-delay: UL (uplink)+DL (downlink)=13.5 ms.

Compared to circuit mode, this represents a saving of around 10 ms.

Half rate transmission scheduling is represented in FIG. 8 of the accompanying drawings.

As can be seen in this figure, the situation is the same as for the full rate: the time-delay UL+DL is 6.7 ms for all time slots.

Taking into account the transcoding time-delay (7 ms), this results in a time-delay UL+DL=13.7 ms.

In comparison to circuit mode, this represents a saving of approximately 14 ms.

With the solution proposed above yielding “synchronized” IP packets, the “Composite IP routing” functional block in FIG. 1 also has some knowledge of the time slot numbers in order to construct appropriate IP frames.

The synchronized transmission described above implies that the equipment responsible for generating the downlink composite IP frame has a perfect knowledge of the organization of the BTS time slots.

This means that said equipment includes, at the Abis interface, a procedure for time alignment with the BTS to obtain precise transmission time information. At the interface with the transcoder, it can use a time alignment (TA) procedure that is more conventional, equivalent to that used between the BTS and the TC for the GSM or between the radio network controller (RNC) and the TC for the Universal Mobile Telecommunication System (UMTS).

The person skilled in the art will note that the invention avoids any additional jitter due to the time alignment procedure when a new channel is launched.

A further improvement to the time-delays can be obtained by reducing the size of the IP frames. For example, by grouping only six TCH, rather than 12, one IP frame duration can be saved (1.9 ms at the full rate, 0.45 ms at the half rate). However, this would make downlink scheduling more difficult because it would be necessary to use the correct priority between IP frames that correspond to the same radio time slot. A simpler improvement could be limited to the uplink alone. This induces no problems in the downlink, but achieves a further saving of 0.9 or 0.2 ms, at the cost of a slight increase in the bandwidth (0.2%).

According to another feature of the invention, providing additional time-delay compensation, a time offset is introduced between the uplink and/or downlink sectors of each base transceiver station of the network.

For example, in the context of the particular embodiment described above (with reference to FIG. 1 in particular), a significant saving can be obtained by introducing a time shift between the three sectors of a site.

If only one third of the TRX are synchronized, the full bandwidth of the Abis interface is available for transmitting only one third of the information.

Ideally, the three sectors are offset in time by 4/3 of a time division multiple access (TDMA) frame, i.e. by 6.13 ms. In practice, it is suggested that they be offset by 10/10/12 time slots to maintain a synchronous clock for the time slots.

The transmission time of an IP frame made up of 4 TCH is 0.63 ms. The transmission time of an IP frame of time slot 7 is 1 ms.

Full rate transmission scheduling in the case of the above time offset is shown in FIG. 9.

The time-delay UL+DL is 0.64 ms.

Compared to specification 03.05, this corresponds to 1.5 ms for Tabisu+Tabisd+Ttransc.

This results in a saving of 21 ms, compared to specification 03.05.

With half rate transmission, the situation appears complex because the three sectors generate 16 voice blocks that partly overlap.

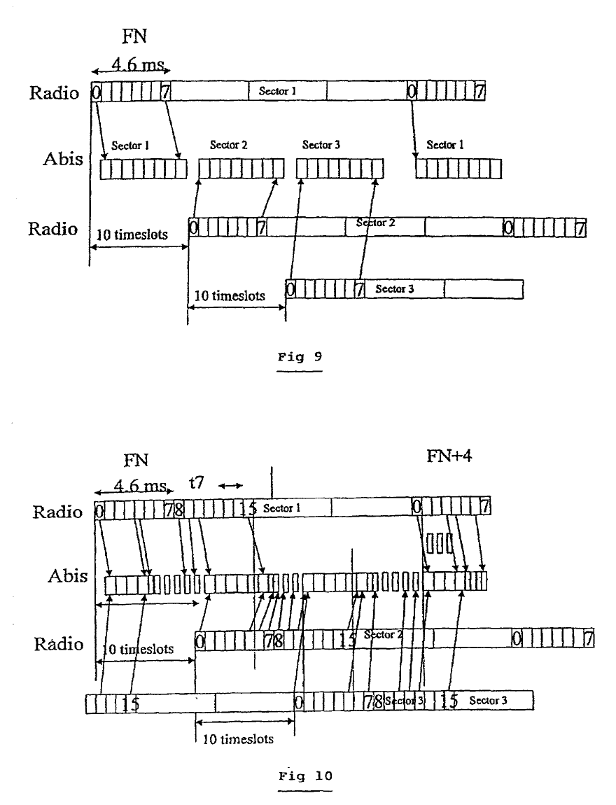

It appears much simpler when it is considered that a composite IP frame contains all the TCH received on the radio link during the same number of time slots (see FIG. 10).

The worst case corresponds, for example (see FIG. 10), to time slot 15 of sector 2: 0.74 ms, which corresponds to an excellent transmission time.

Of course, the same offset time-delay compensation technique can be used on the downlink. For simplicity, it is not shown in the accompanying drawings.

The transmission time-delay UL+DL is of the order of 1.1 ms.

With the transcoding time-delay, this represents 8.1 ms.

The introduction of a time offset between the sectors of a BTS has certain consequences for the system.

Thus it is not possible to re-use the sequences of one of them. In reality, this stems from the use of a common group of frequencies in the three sectors, collisions being avoided by using the same sequence number (HSN) and a different index offset (MAIO). Because of the reduced number of TRX available on a site, the time offset feature may be considered as optional.

The time slot synchronization is insufficient for totally synchronous transfer. This can be resolved either by offsetting the sectors by 8 time slots (=1 frame) instead of 10 (slightly less effective) or by using a transfer presynchronized with the same time alignment (TA) in the source and target cells (only for phase 2 mobiles, but the number of phase 1 mobiles, forced to use asynchronous transfer, is now very small).

The present invention also provides a radiocommunication network using packet transmission and including a plurality of base transceiver stations to each of which can be connected a plurality of transcoders or transcoder modules forming part of a fixed telephone network or a like network, which radiocommunication network uses the transmission method described hereinabove.

The invention consequently minimizes the transmission time-delays between a radiocommunication network and a fixed telephone network and makes the transmission time-delays uniform for all the mobile terminals connected to said radiocommunication network and communicating with a terminal of said fixed network.

Accordingly, by selecting a packetizer and transmission algorithm that is optimized, the introduction of packet transmission with the characteristics previously cited significantly reduces the voice time-delay. A saving of 20 ms can be obtained at the full rate and at the half rate if there is no IP equipment between the transcoder and the BTS (with 3×4 TRX).

Of course, the invention is not limited to the embodiment described and shown in the accompanying drawings, which can be modified, without departing from the scope of protection of the invention, in particular from the point of view of the composition of its component parts or by substituting technical equivalents.

There is claimed:

1. A synchronized bidirectional packet transmission method between a base station of a radiocommunication network and a transcoder unit including at least two transcoders, forming part of a fixed telephone network or the like and connected to said base transceiver station, in particular to transmit voice or sound information or data, which method uses a downlink priority order for the time slots of a frame that is reversed relative to that applied to or existing on the uplink.

2. The method claimed in claim 1 wherein a time offset is introduced between the uplink and/or downlink sectors of each base transceiver station of the network.

3. A radiocommunication network using packet transmission and including a plurality of base transceiver stations to each of which can be connected a plurality of transcoders or transcoder modules forming part of a fixed telephone network or a like network, which radiocommunication network uses the transmission method claimed in claim 1.

4. A base transceiver station using the method claimed in claim 1.

5. A transcoder unit using the method claimed in claim 1.
